(19) United States
(12) Patent Application Publication
(10) Pub. No.: US 2026/0011928 A1
(43) Pub. Date: Jan. 8, 2026

(54) INTELLIGENT REFLECTING SURFACE

(71) Applicant: Japan Display Inc., Tokyo (JP)

(72) Inventors: Daiichi SUZUKI, Tokyo (JP); Shinichiro OKA, Tokyo (JP); Mitsutaka OKITA, Tokyo (JP); Kazuki MATSUNAGA, Tokyo (JP)

(73) Assignee: Japan Display Inc., Tokyo (JP)

(21) Appl. No.: 19/330,846

(22) Filed: Sep. 17, 2025

Related U.S. Application Data
(63) Continuation of application No. PCT/JP2024/002235, filed on Jan. 25, 2024.

(30) Foreign Application Priority Data
Mar. 24, 2023 (JP) 2023-047968

(51) Int. Cl. H01Q 15/14

(52) U.S. Cl. CPC H01Q 15/147

(57) ABSTRACT

A reflecting device includes a patch electrode, a common electrode that faces the patch electrodes and is separated from the patch electrode, and a liquid crystal layer between the patch electrode and the common electrode, wherein the patch electrode has a first metal layer with a first through hole, and a first transparent conductive layer stacked on the first metal layer and overlapping the first through hole, and the common electrode has a second metal layer with a second through hole overlapping the first through hole in a plan view, and a second transparent conductive layer stacked on the second metal layer and overlapping the second through hole. Furthermore, the patch electrode comprises a plurality of patch electrodes arranged on a plane of incidence of radio waves, and the common electrode is arranged on a rear side of the plurality of patch electrodes.

### CROSS-REFERENCE TO RELATED APPLICATIONS

This application is a Continuation of International Patent Application No. PCT/JP2024/002235, filed on Jan. 25, 2024, which claims the benefit of priority to Japanese Patent Application No. 2023-047968, filed on Mar. 24, 2023, the entire contents of each are incorporated herein by reference.

### FIELD

An embodiment of the present invention relates to a reflecting device.

### BACKGROUND

Phased array antenna devices control directivity by adjusting the amplitude and phase of high-frequency signals applied to each of a plurality of antenna elements arranged in a plane while the antenna is fixed in position. The phased array antenna devices require a phase shifter. The phased array antenna devices using a phase shifter that utilizes changes in a dielectric constant due to the alignment state of liquid crystals has been disclosed (For example, refer to Japanese laid-open patent publication No. H11-103201). Additionally, as an example of a device that reflects radio waves, a liquid crystal meta-surface reflector that can change the reflection direction of radio waves by utilizing the dielectric anisotropy of liquid crystals has been disclosed (For example, refer to Japanese laid-open patent publication No. 2019-530387).

### SUMMARY

A reflecting device in an embodiment according to the present invention includes a patch electrode, a common electrode that faces the patch electrode and is separated from the patch electrode, and a liquid crystal layer between the patch electrode and the common electrode, wherein the patch electrode has a first metal layer with a first through hole, and a first transparent conductive layer stacked on the first metal layer and overlapping the first through hole, and the common electrode has a second metal layer with a second through hole overlapping the first through hole in a plan view, and a second transparent conductive layer stacked on the second metal layer and overlapping the second through hole.

### BRIEF DESCRIPTION OF DRAWINGS

FIG. 1A is a plan view of a reflecting element utilized in a reflecting device according to an embodiment of the present invention.

FIG. 1B is a cross-sectional view of a reflecting element utilized in a reflecting device according to an embodiment of the present invention.

FIG. 2A is a diagram showing a state in which no voltage is applied between a patch electrode and a common electrode when a reflecting element utilized in a reflecting device according to an embodiment of the present invention operates.

FIG. 2B is a diagram showing a state in which a voltage is applied between a patch electrode and a common electrode when a reflecting element used in a reflecting device according to an embodiment of the present invention operates.

FIG. 3 is a diagram showing a state in which a voltage is applied between a patch electrode and a common electrode when a reflecting element used in a reflecting device according to an embodiment of the present invention operates.

FIG. 4 is a plan view of a reflecting device according to an embodiment of the present invention.

FIG. 5A is a plan view of a second substrate utilized in a reflecting device according to an embodiment of the present invention.

FIG. 5B is a plan view of a second substrate utilized in a reflecting device according to an embodiment of the present invention.

FIG. 6 is a schematic diagram showing a change in the traveling direction of a reflected wave by a reflecting device according to an embodiment of the present invention.

FIG. 7 is a plan view of a reflecting device according to an embodiment of the present invention.

FIG. 8 is a cross-sectional view of a reflecting device according to an embodiment of the present invention.

FIG. 9 is a diagram showing a state in which a voltage is applied between a patch electrode and a common electrode when a reflecting element used in a reflecting device operates.

### DESCRIPTION OF EMBODIMENTS

Hereinafter, embodiments of the present invention are described with reference to the drawings. However, the present invention can be implemented in many different aspects, and should not be construed as being limited to the description of the following embodiments. For the sake of clarifying the explanation, the drawings may be expressed schematically with respect to the width, thickness, shape, and the like of each part compared to the actual aspect, but the drawings are only an example and do not limit the interpretation of the present invention. In this specification and each drawing, elements similar to those described previously with respect to previous drawings may be given the same reference sign (or a number followed by a, b, etc.) and a detailed description may be omitted as appropriate. The terms “first” and “second” appended to each element are a convenience sign used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

As used herein, a reflecting device (radio wave reflecting device) is also referred to as an IRS (Intelligent Reflecting Surface) or the like.

### 1. Reflecting Element

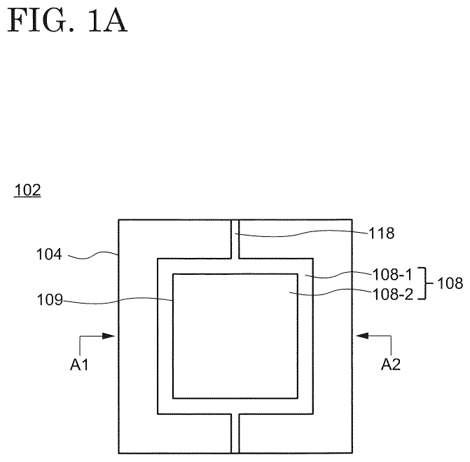

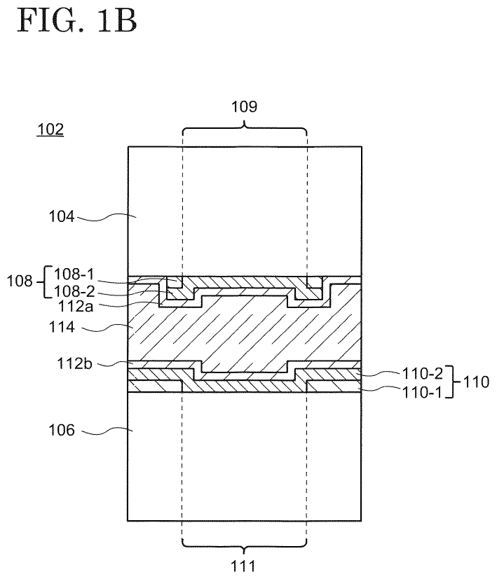

FIG. 1A and FIG. 1B show a reflecting element 102 used in a reflecting device according to an embodiment of the present invention. FIG. 1A shows a plan view of the reflecting element 102 viewed from above (a side where radio waves enter), and FIG. 1B shows a cross-sectional view between A1-A2 shown in a plan view.

As shown in FIG. 1A and FIG. 1B, the reflecting element 102 includes a first substrate 104, a second substrate 106, a patch electrode 108, a common electrode 110, a liquid crystal layer 114, an alignment film 112a, and an alignment film 112b. The patch electrode 108 is arranged on the first substrate 104, and the common electrode 110 is arranged on the second substrate 106. In the reflecting element 102, the first substrate 104, on which the patch electrode 108 is provided, is arranged on the plane of incidence of radio waves. The alignment film 112a is provided on the first substrate 104 so as to cover the patch electrode 108, and the alignment film 112b is provided on the second substrate 106 so as to cover the common electrode 110. The patch electrode 108 and the common electrode 110 are arranged to face each other, and the liquid crystal layer 114 is sandwiched between the patch electrode 108 and the common electrode 110. The alignment film 112a is present between the patch electrode 108 and the liquid crystal layer 114, and the alignment film 112b is present between the common electrode 110 and the liquid crystal layer 114.

The patch electrode 108 is preferably symmetrical with respect to the vertical and horizontal polarization of the irradiated radio wave, and has a quadrangle shape or a circular shape in a plan view. FIG. 1A shows the case where the patch electrode 108 has a square shape in a plan view.

The patch electrode 108 has a metal layer 108-1 and a transparent conductive layer 108-2. Furthermore, the patch electrode 108 has a through hole 109. The metal layer 108-1 is a frame-shaped electrode that forms the through hole 109. The transparent conductive layer 108-2 is provided overlapping the through hole 109. The transparent conductive layer 108-2 is in contact with the metal layer 108-1 and is arranged to extend over the entire surface of the through hole 109, as shown in FIG. 1A and FIG. 1B. Specifically, the transparent conductive layer 108-2 has a portion overlapping the through hole 109 and a portion stacked with the metal layer 108-1, as shown in FIG. 1B. In FIG. 1B, when the surface on which the patch electrode 108 of the first substrate 104 is provided is considered to be the upper surface, the transparent conductive layer 108-2 is provided so as to be in contact with the upper surface of the metal layer 108-1.

Although the transparent conductive layer 108-2 is patterned to match the outer shape of the metal layer 108-1 in FIG. 1A and FIG. 1B, it may be provided so as to cover the outer side of the metal layer 108-1, for example. In addition, the transparent conductive layer 108-2 may be formed on the first substrate 104, and the metal layer 108-1 may be formed stacked on the transparent conductive layer 108-2.

Furthermore, FIG. 1B shows a configuration in which the metal layer 108-1 and the transparent conductive layer 108-2 are directly connected, but the metal layer 108-1 and the transparent conductive layer 108-2 may be electrically connected via a contact hole formed in an insulating film provided between the metal layer 108-1 and the transparent conductive layer 108-2.

There is no limitation on the material used to form the metal layer 108-1, and a metal material with low resistivity can be used. For example, metal films such as aluminum (Al) and copper (Cu) can be used for the metal layer 108-1.

The material used to form the transparent conductive layer 108-2 is a metal oxide that is highly transparent and conductive. Specifically, the transparent conductive layer 108-2 may have a stacked structure of a transparent conductive layer with a high work function, such as an indium oxide-based transparent conductive layer (e.g., ITO) or a zinc oxide-based transparent conductive layer (e.g., IZO, ZnO), and a metal film. As mentioned above, when directly connecting to the metal layer 108-1, it is desirable that the work function of the material used for the metal layer 108-1 is close to the work function of the material used for the transparent conductive layer 108-2

The metal layer 108-1 and the transparent conductive layer 108-2 can be formed using different materials as described above. By forming the metal layer 108-1 and the transparent conductive layer 108-2 using different materials, the transmittance of visible light and the reflectivity of radio waves of the reflecting element 102 can be determined as necessary. For example, in order to increase radio wave reflectivity, the through hole 109 of the patch electrode 108 can be made smaller, and in order to increase visible light transmittance, the through hole 109 can be made larger. Thus, by providing the transparent conductive layer 108-2 in the through hole 109, it is possible to maintain the area necessary for the patch electrode 108 without obstructing the light passing through the through hole 109.

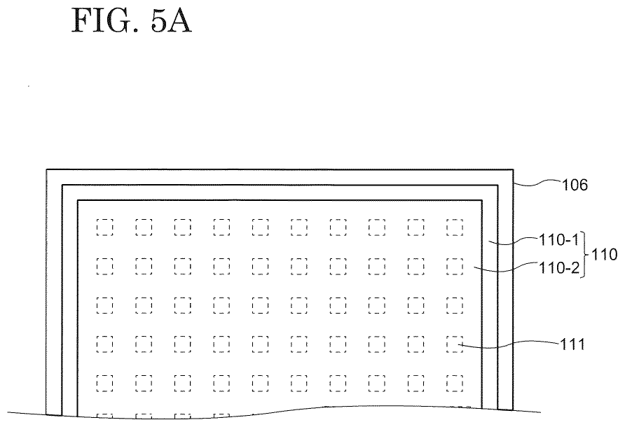

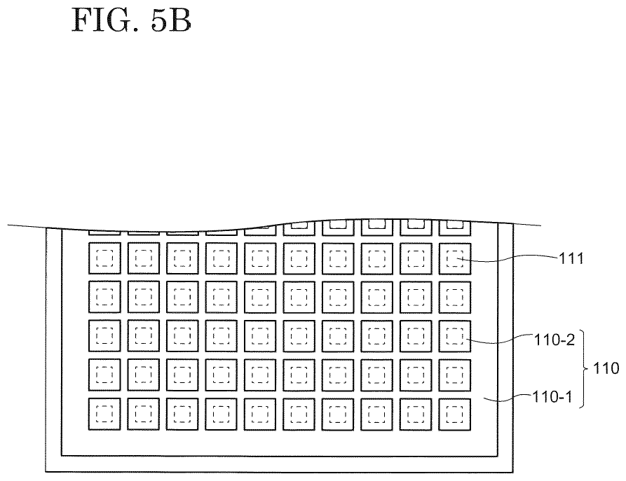

The common electrode 110 has a metal layer 110-1 and a transparent conductive layer 110-2. The metal layer 110-1 has a through hole 111. The metal layer 110-1 has a plurality of through holes 111 (see FIGS. 5A and 5B). The transparent conductive layer 110-2 is arranged in the through hole 111. The transparent conductive layer 110-2 is provided so as to fill the through hole 111. The transparent conductive layer 110-2 may also be provided on the metal layer 110-1.

The transparent conductive layer 110-2 is shown in FIG. 1B as being formed on the metal layer 110-1 on the second substrate 106, but the transparent conductive layer 110-2 may be formed on the second substrate 106, and the metal layer 110-1 may be formed on the transparent conductive layer 110-2.

Furthermore, FIG. 1B shows a configuration in which the metal layer 110-1 and the transparent conductive layer 110-2 are directly connected, but the metal layer 110-1 and the transparent conductive layer 110-2 may be electrically connected via a contact when an interlayer film, an insulating film, etc. is formed between the metal layer 110-1 and the transparent conductive layer 110-2.

There is no particular limitation on the shape of the common electrode 110 as a whole, and as will be described in detail later, it has a shape that extends over substantially the entire surface of the second substrate 106 so as to have a larger area than the patch electrode 108 (see FIG. 5A).

There is no limitation on the material used to form the metal layer 110-1, and the same material used for the metal layer 108-1 can be used.

The material used to form the transparent conductive layer 110-2 can be the same as the material used for the transparent conductive layer 108-2.

The first substrate 104 may be provided with a first wiring 118. The first wiring 118 is connected to the patch electrode 108. The first wiring 118 can be used when applying a control signal to the patch electrode 108. In addition, when a plurality of reflecting elements is arranged, the first wiring 118 can be used when connecting a certain patch electrode and an adjacent patch electrode.

Although not shown in FIGS. 1A and 1B, the first substrate 104 and the second substrate 106 are bonded together by a sealant. The first substrate 104 and the second substrate 106 are oppositely arranged with a gap therebetween, and the liquid crystal layer 114 is provided within an area surrounded by the sealant. The liquid crystal layer 114 is provided so as to fill the gap between the first substrate 104 and the second substrate 106. A distance between the first substrate 104 and the second substrate 106 is 20 to 100 μm, for example, a distance of 50 μm in this case. Since the patch electrode 108, the common electrode 110, the alignment film 112a, and the alignment film 112b are disposed between the first substrate 104 and the second substrate 106, the distance between the alignment film 112a and the alignment film 112b disposed on each of the first substrate 104 and the second substrate 106 is precisely the thickness of the liquid crystal layer 114. Although not shown in FIG. 1B, a spacer may be disposed between the first substrate 104 and the second substrate 106 to keep the distance constant.

A control signal is applied to the patch electrode 108 to align liquid crystal molecules in the liquid crystal layer 114. The control signal is a DC voltage signal or a polarity inversion signal in which positive and negative DC voltages are alternately inverted. The common electrode 110 is applied with a voltage at ground or at an intermediate level of the polarity reversal signal. When the control signal is applied to the patch electrode 108, the alignment state of the liquid crystal molecules contained in the liquid crystal layer 114 is changed. Liquid crystal materials having dielectric constant anisotropy are used for the liquid crystal layer 114. For example, nematic, smectic, cholesteric, and discotic liquid crystals are used as the liquid crystal layer 114. The liquid crystal layer 114 with dielectric constant anisotropy has a dielectric constant that changes due to changes in the alignment state of the liquid crystal molecules. The reflecting element 102 can change the dielectric constant of the liquid crystal layer 114 by the control signal applied to the patch electrode 108, thereby delaying the phase of the reflected wave when radio waves are reflected.

The frequency bands of radio waves reflected by the reflecting element 102 are the very short wave (VHF: Very High Frequency) band, ultra short wave (UHF: Ultra-High Frequency) band, microwave (SHF: Super High Frequency) band, submillimeter wave (THF: Tremendously High Frequency), and millimeter wave (EHF: Extra High Frequency) band. Although the liquid crystal molecules in the liquid crystal layer 114 align themselves in response to the control signal applied to the patch electrode 108, they hardly follow the frequency of the radio waves irradiated to the patch electrode 108. Therefore, the reflecting element 102 can control the phase of the reflected radio waves without being affected by radio waves.

Next, the alignment state of the liquid crystal layer 114 when a voltage is applied to the patch electrode 108 and the common electrode 110 of the reflecting element 102 will be described.

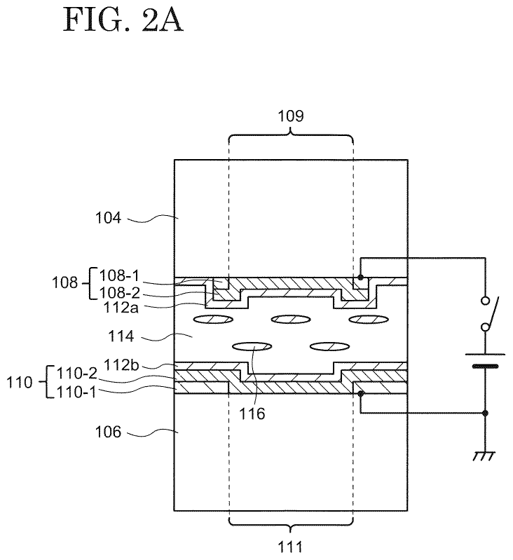

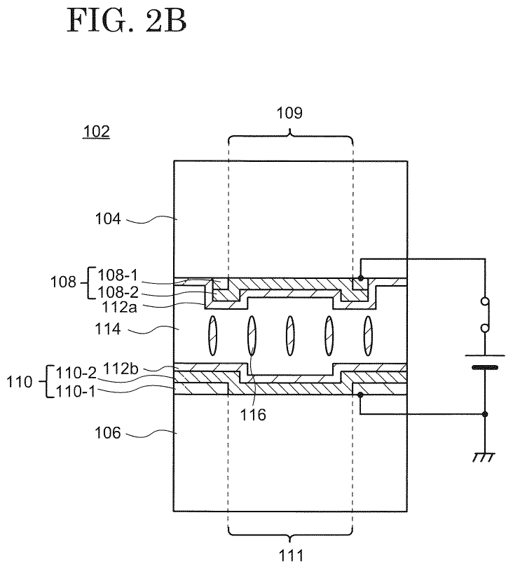

FIG. 2A shows a state (“first state”) in which a voltage is not applied between the patch electrode 108 and the common electrode 110. FIG. 2A shows an example where the alignment film 112a and the alignment film 112b are horizontally aligned films. The long axis of the liquid crystal molecules 116 in the first state is aligned horizontally with respect to the surfaces of the patch electrode 108 and the common electrode 110 by the alignment film 112a and the alignment film 112b. FIG. 2B shows a state (“second state”) in which a control signal (voltage signal) is applied to the patch electrode 108. The liquid crystal molecules 116 are aligned in the second state with the long axis perpendicular to the surfaces of the patch electrode 108 and the common electrode 110 under the effect of the electric field. According to the magnitude of the control signal applied to the patch electrode 108 (magnitude of the voltage between the counter electrode and the patch electrode), it is possible to align the angle at which the long axis of the liquid crystal molecules 116 is aligned in an intermediate direction between the horizontal and vertical directions.

When the liquid crystal molecules 116 have positive dielectric constant anisotropy, the dielectric constant is larger in the second state relative to the first state. When the liquid crystal molecules 116 have negative dielectric constant anisotropy, the dielectric constant is smaller in the second state relative to the first state. The liquid crystal layer 114 having dielectric anisotropy can be regarded as a variable dielectric layer. The reflecting element 102 can be controlled to delay (or not) the phase of the reflected wave by using the dielectric constant anisotropy of the liquid crystal layer 114.

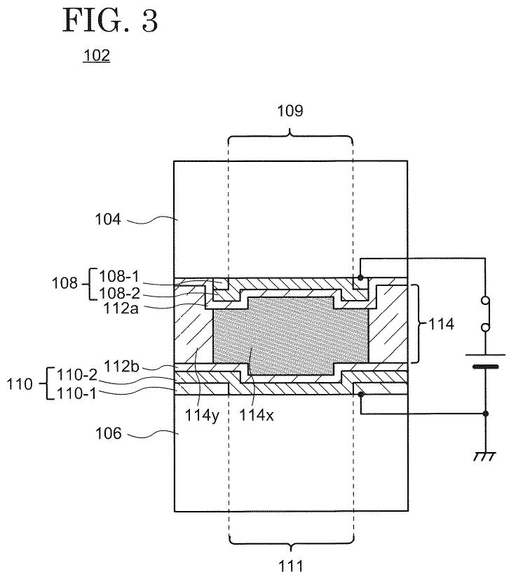

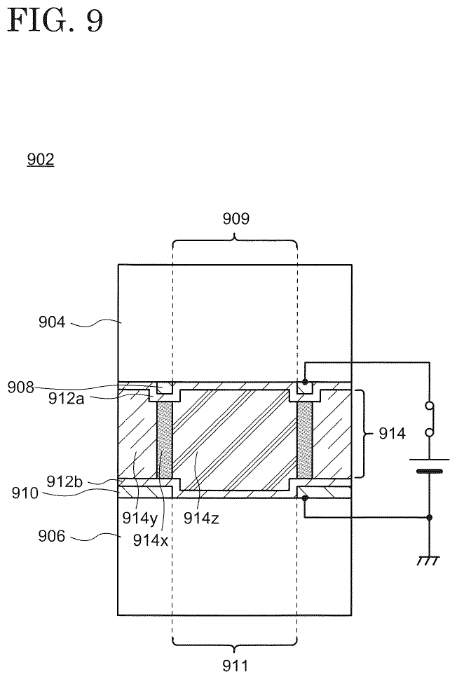

Here, referring to FIG. 3 and FIG. 9, the alignment state of the liquid crystal layer in the reflecting element 102, in which a transparent conductive layer 108-2 is provided in the through hole 109 of the patch electrode 108, and the reflecting element 902, in which only the through hole 911 is formed in the patch electrode 908, are shown.

FIG. 3 shows a state in which a voltage for controlling the alignment state of the liquid crystal is applied between the patch electrode 108 and the common electrode 110, and similarly, FIG. 9 shows a state in which a voltage for controlling the alignment state of the liquid crystal is applied between the patch electrode 908 and the common electrode 910.

The patch electrode 108 of the reflecting element 102 has the through hole 109 in the metal layer 108-1, as described above, and further has the transparent conductive layer 108-2 arranged so as to overlap the through hole 109. Furthermore, the common electrode 110 of the reflecting element 102 has a through hole 111 in the metal layer 110-1 and further has a transparent conductive layer 110-2 arranged so as to overlap the through hole 111.

Next, the reflecting element 902, which has a different structure from the reflecting element 102, will be described. The patch electrode 908 of the reflecting element 902 has a through hole 909, as shown in FIG. 9. Also, the common electrode 910 of the reflecting element 902 has a through hole 911. In other words, the patch electrode 908 of the reflecting element 902 has the same shape as the metal layer 108-1 of the reflecting element 102, and the common electrode 910 has the same shape as the metal layer 110-1 of the reflecting element 102. However, no conductive layer such as the transparent conductive layer 108-2 is formed in the through hole 909 and the through hole 911.

The liquid crystal layer 114 of the reflecting element 102 has a liquid crystal layer 114x in which liquid crystal molecules are aligned between the patch electrode 108 and the common electrode 110, as shown in FIG. 3. The liquid crystal layer 114x, which indicates the alignment state of the liquid crystal molecules, indicates, for example, the alignment state of the liquid crystal molecules 116 shown in FIG. 2B. Since the liquid crystal layer 114y is not positioned between the patch electrode 108 and the common electrode 110, it exhibits a state such as that shown by the liquid crystal molecules 116 in FIG. 2A, for example.

The patch electrode 108 of the reflecting element 102 is provided with the transparent conductive layer 108-2 that is electrically connected to the metal layer 108-1 and is arranged in the through hole 109, so that a voltage having the same potential as the metal layer 108-1 is applied to the transparent conductive layer 108-2. Therefore, the voltage can be applied to the entire patch electrode 108 including the through hole 109. Moreover, since the transparent conductive layer 110-2 is provided on the common electrode 110 of the reflecting element 102, which is electrically connected to the metal layer 110-1 and arranged in the through hole 111, a voltage having the same potential as the metal layer 110-1 is applied to the transparent conductive layer 110-2. Therefore, the voltage can be applied to the entire common electrode 110 including the through hole 111.

As shown in FIG. 9, the liquid crystal layer 914 of the reflecting element 902 has a liquid crystal layer 914x showing a state in which liquid crystal molecules are aligned between the outer peripheral portion of the patch electrode 908 excluding the through hole 909 and the outer peripheral portion of the common electrode 910 excluding the through hole 911. A liquid crystal layer 914z is provided between the through hole 909 of the patch electrode 908 and the through hole 911 of the common electrode 910. The liquid crystal layer 914z shows a state in which the patch electrode 108 and common electrode 110 shown in FIG. 2B are applied with a voltage, but the alignment is insufficient compared to the liquid crystal molecules 116 in the liquid crystal layer 114x, or the liquid crystal molecules 116 are not aligned.

As described above, it can be seen that the reflecting element 102 of the present embodiment can also operate the liquid crystal layer 114 located between the through hole 109 and the through hole 111, but the reflecting element 902 cannot sufficiently operate the liquid crystal layer 914 located between the through hole 909 and the through hole 911

According to the present embodiment, since the transparent conductive layer 108-2 and the transparent conductive layer 110-2 are provided so as to overlap the through hole 109 of the patch electrode 108 and the through hole 111 of the common electrode 110, the transparency of the patch electrode 108 and the common electrode 110 can be maintained, and the conductivity of the patch electrode 108 and the common electrode 110 can be maintained. The transparency and conductivity of the patch electrode 108 and the common electrode 110 can be maintained.

### 2. Reflecting Device

Next, the structure of the reflecting device in which the reflecting elements are integrated is shown.

### 2-1. Reflecting Device A (Uniaxial Reflection Control)

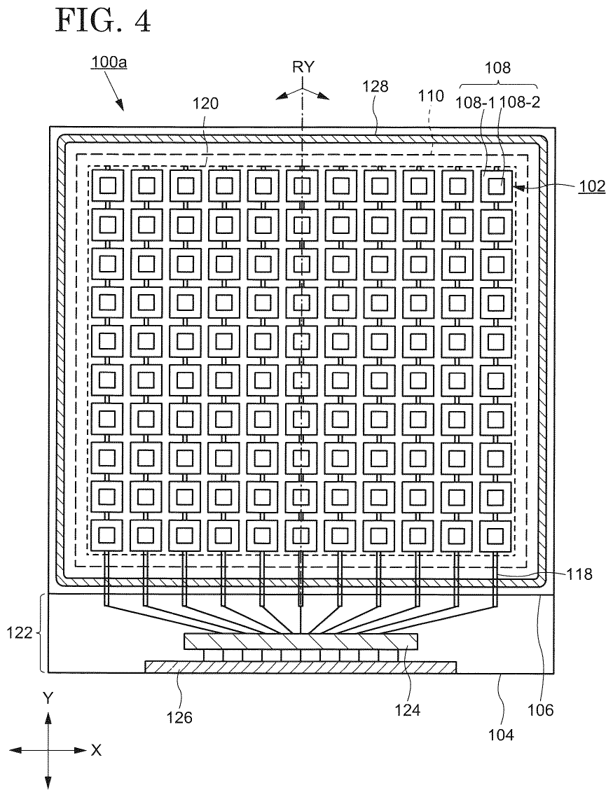

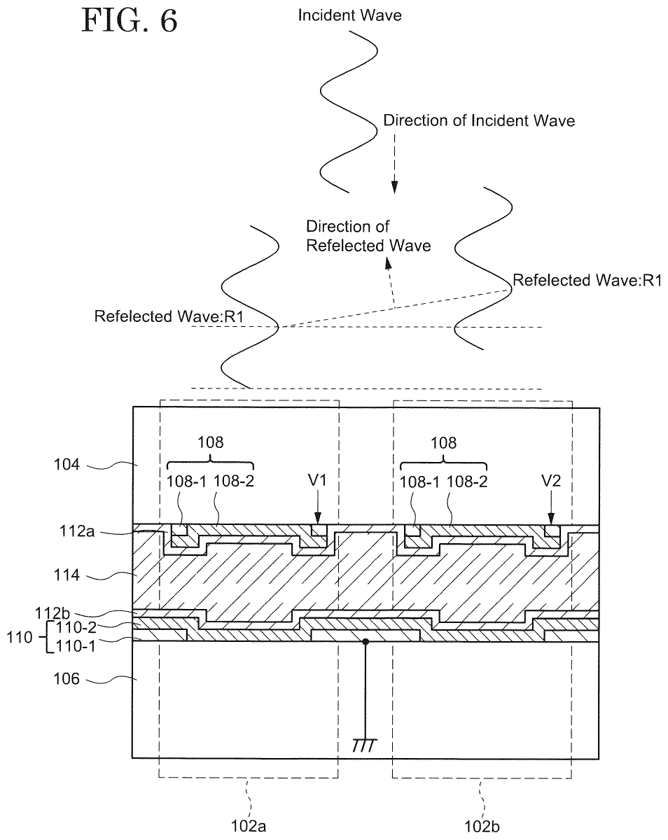

FIG. 4 shows a configuration of a reflecting device 100a according to an embodiment of the present invention. The reflecting device 100a includes a reflector 120. The reflector 120 is configured with a plurality of reflecting elements 102. The plurality of reflecting elements 102 are arranged, for example, in a first direction (X-axis direction shown in FIG. 4) and in a second direction (Y-axis direction shown in FIG. 6) that intersects the first direction. The plurality of reflecting elements 102 are arranged so that the patch electrodes 108 face the plane of incidence of radio waves. The reflector 120 is flat, and the plurality of patch electrodes 108 are arranged in this flat plane in a matrix.

The reflecting device 100 has a structure in which the plurality of reflecting elements 102 are integrated on a single first substrate 104. As shown in FIG. 4, the reflecting device 100 has a structure in which a first substrate 104 with an array of the plurality of patch electrodes 108 and the second substrate 106 with the common electrode 110 are arranged on top of each other, and the liquid crystal layer (not shown) is disposed between the two substrates. The reflector 120 is formed in the region where the plurality of patch electrodes 108 and the common electrode 110 are superimposed. A cross-sectional structure of the reflector 120 is the same as that of the reflecting element 102 shown in FIG. 1B when viewed with respect to the individual patch electrodes 108. The first substrate 104 and the second substrate 106 are bonded to each other by the sealant 128, and the liquid crystal layer, not shown, is disposed in the region inside the sealant 128.

The second substrate 106 has the common electrode 110 that extends over substantially the entire surface of the second substrate 106 so that it has a larger area than the patch electrode 108. FIG. 5A and FIG. 5B show plan views of the second substrate 106 with the common electrode 110 formed thereon. As shown in FIG. 5A, a plurality of through holes 111 are provided in the common electrode 110. As described above, the plurality of through holes 111 are provided so as to overlap the through holes 109 of the patch electrode 108. The metal layer 110-1 and the transparent conductive layer 110-2 of the common electrode 110 are stacked, and the transparent conductive layer 110-2 is provided so as to overlap the plurality of through holes 111. The transparent conductive layer 110-2 may be formed so as to extend over substantially the entire surface of the second substrate 106, as shown in FIG. 5A, or may be patterned into a shape corresponding to the patch electrodes 108, as shown in FIG. 5B. The transparent conductive layer 110-2 may be formed so as to overlap the entire surface of each through hole 111, as shown in FIG. 5B.

The first substrate 104 has a peripheral area 122 that extends outward from the second substrate 106 in addition to the area that faces the second substrate 106. The peripheral region 122 is disposed with a first driver circuit 124 and a terminal part 126. The first driver circuit 124 outputs control signals to the patch electrode 108. The terminal part 126 is a region that forms a connection with an external circuit, for example, a connected flexible printed circuit board, not shown. Signals for controlling the first driver circuit 124 are input to the terminal part 126.

As described above, the plurality of patch electrodes 108 are arranged on the first substrate 104 in the first (X-axis) direction and the second (Y-axis) direction. A plurality of first wirings 118 extending in the second direction (Y-axis direction) are arranged on the first substrate 104. Each of the plurality of first wirings 118 is electrically connected to the plurality of patch electrodes 108 arranged in the second direction (Y-axis direction). In other words, the plurality of patch electrodes 108 arranged in the second direction (Y-axis direction) are connected by the first wiring 118. The reflector 120 has a configuration of a plurality of patch electrode arrays in a single row connected by the first wiring 118 in the first direction (X-axis direction). FIG. 4 shows an example in which the patch electrodes 108 are connected in each row (Y-axis direction) array.

The plurality of first wirings 118 arranged on the reflector 120 extend to the peripheral region 122 and are connected to the first driver circuit 124. The first driver circuit 124 outputs control signals to be applied to the patch electrode 108. The first driver circuit 124 can output control signals of different voltage levels to each of the plurality of first wirings 118. As a result, the control signal is applied to the plurality of patch electrodes 108 arranged in the first (X-axis) and second (Y-axis) directions in the reflector 120, row by row (for each patch electrode 108 arranged in the second direction (Y-axis direction)).

A control signal is applied to each pair of the plurality of patch electrodes 108 arranged in the second direction (Y-axis direction) in the reflecting device 100a. Thereby, the direction of reflection of the reflected wave of a radio wave incident on the reflector 120 can be controlled. That is, the reflecting device 100a can control the direction of travel of the reflected wave in the left and right directions on the drawing with respect to the reflection axis RY, which is parallel to the second direction (Y-axis direction), of the radio wave irradiated on the reflector 120.

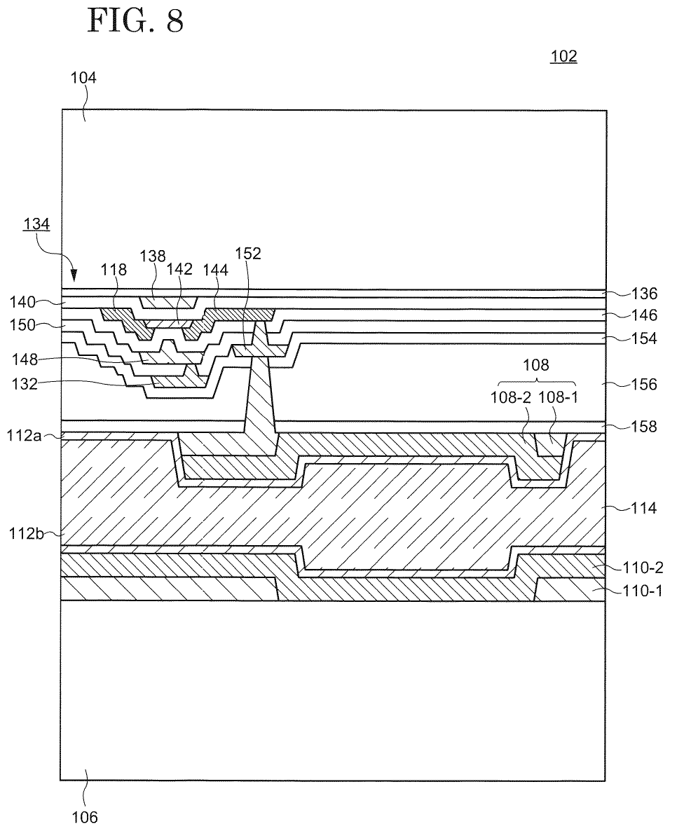

FIG. 6 schematically shows that the direction of travel of the reflected wave is changed by the two reflecting elements 102. In the case where radio waves are incident on the first reflecting element 102a and the second reflecting element 102b at the same phase, since different control signals (V1≠V2) are applied to the first reflecting element 102a and the second reflecting element 102b, the phase change of the reflected wave by the second reflecting element 102b is larger than that of the first reflecting element 102a. As a result, the phase of the reflected wave R1 reflected by the first reflecting element 102a and the phase of the reflected wave R2 reflected by the second reflecting element 102b differ (in FIG. 8, the phase of the reflected wave R2 is more advanced than that of the reflected wave R1), and the apparent traveling direction of the reflected wave changes obliquely.

In FIG. 4, since the plurality of patch electrodes 108 arranged in the second direction (Y-axis direction) are electrically connected by the first wiring 118 and are electrically equipotential, it is also possible to replace it with a strip electrode continuous in the second direction (Y-axis direction) instead of a plurality of divided shapes. However, since the dimensions of the patch electrode 108 have an appropriate range depending on the wavelength of the reflected radio wave, when it is made into a strip electrode, the sensitivity to the target wavelength is reduced and the behavior towards the vertical polarization wave and horizontal polarization wave is different. Therefore, as shown in FIG. 4, it is preferable to arrange the patch electrodes 108 in an array having a shape that is symmetrical with respect to a vertical polarization wave and a horizontal polarization wave (FIG. 4 shows a square, but it may be circular) and to connect the plurality of patch electrodes 108 that are arranged parallel to the reflection axis RY by the first wiring 118.

### 2-2. Reflecting Device B (Biaxial Reflection Control)

Since the reflecting device 100a has a single reflection axis RY, the reflection angle can be controlled in the direction with the reflection axis RY as the axis of rotation. In contrast, this embodiment shows an example of a reflecting device 100b that is capable of biaxial reflection control. The following explanation focuses on the parts that differ from the reflecting device 100a.

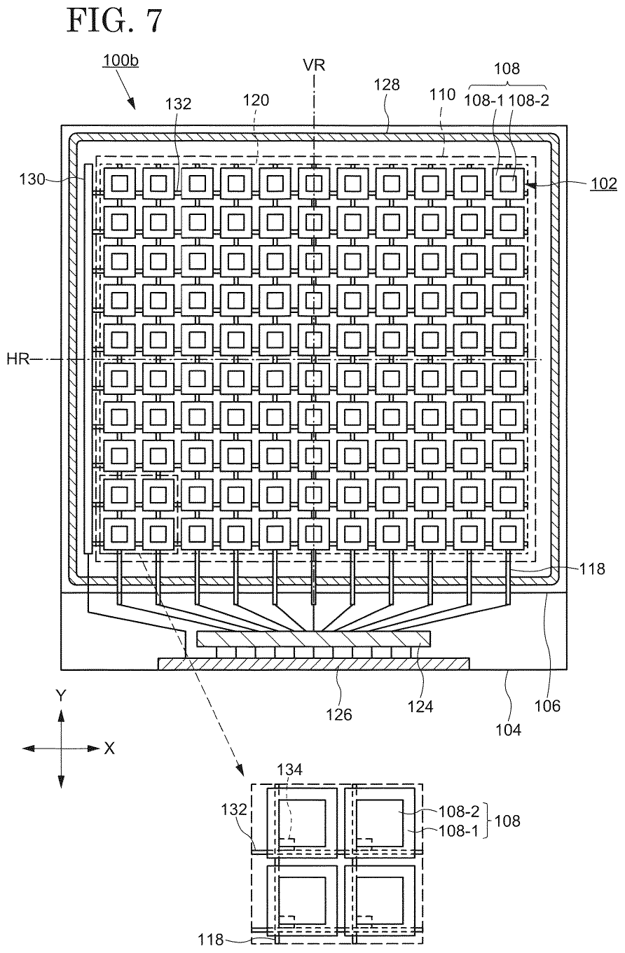

FIG. 7 shows the configuration of the reflecting device 100b. The following description will focus on the differences from the reflecting device 100a shown in FIG. 4.

The reflecting device 100b has a plurality of second wirings 132 extending in the first direction (X-axis direction) in addition to a plurality of first wirings 118 extending in the second direction (Y-axis direction) in the reflector 120. The plurality of first wirings 118 and the plurality of second wirings 132 are arranged to intersect across an insulating layer not shown in the diagram. The plurality of first wirings 118 are connected to a first driver circuit 124, and the plurality of second wirings 132 are connected to a second driver circuit 130. The first driver circuit 124 outputs control signals and the second driver circuit 130 outputs scanning signals.

FIG. 7 shows an enlarged inset of the arrangement of the four patch electrodes 108, the first wirings 118 and the second wirings 132. Each of the four patch electrodes 108 is disposed with a switching element 134. Each of the four patch electrodes 108 is electrically connected to the switching element 134. Switching (on and off) of the switching element 134 is controlled by the scanning signal applied to the second wiring 132. A control signal is applied from the first wiring 118 to the patch electrode 108 where the switching element 134 is turned on. The switching element 134 is formed, for example, by a thin-film transistor. According to this configuration, the plurality of patch electrodes 108 arranged in the first direction (X-axis direction) can be selected row by row, and control signals of different voltage levels can be applied to each row. FIG. 7 shows an example in which the patch electrodes 108 are connected to the second wiring 132 and switching elements 134 arranged for each row (X-axis direction) via the switching elements 134 arranged for each patch electrode 108, and the patch electrodes 108 are selected row by row, and control signals with different voltage levels are applied to each row.

The reflecting device 100b shown in FIG. 7 can control the direction of travel of the reflected wave in the left and right directions on the drawing, centered on the reflection axis VR parallel to the second direction (Y-axis direction), when the radio wave is irradiated on the reflector 120, furthermore, the direction of travel of the reflected wave can also be controlled in the vertical direction on the drawing, centered on the reflection axis HR parallel to the first direction (X-axis direction). That is, since the reflecting device 100b has the reflection axis VR parallel to the second direction (Y-axis direction) and the reflection axis VH parallel to the first direction (X-axis direction), the reflection angle can be controlled in the direction with the reflection axis VR as the axis of rotation and in the direction with the reflection axis HR as the axis of rotation.

FIG. 8 shows an example of the cross-sectional structure of the reflecting element 102 with the switching element 134 connected to the patch electrode 108. The switching element 134 is disposed on the first substrate 104. The switching element 134 is a transistor and has a stacked structure of a first gate electrode 138, a first gate insulation layer 140, a semiconductor layer 142, a second gate insulation layer 146, and a second gate electrode 148. An undercoat layer 136 may be disposed between the first gate electrode 138 and the first substrate 104. The first wiring 118 is disposed between the first gate insulating layer 140 and the second gate insulating layer 146. The first wiring 118 is disposed in contact with the semiconductor layer 142. A first connecting wiring 144 is disposed on the same layer as the conductive layer forming the first wiring 118. The first connecting wiring 144 is disposed in contact with the semiconductor layer 142. The connection structure of the first wiring 118 and the first connecting wiring 144 to the semiconductor layer 142 shows a structure in which one wiring is connected to the source of the transistor and the other wiring is connected to the drain.

A first interlayer insulating layer 150 is disposed to cover the switching element 134. The second wiring 132 is disposed on the first interlayer insulating layer 150. The second wiring 132 is connected to the second gate electrode 148 through a contact hole formed in the first interlayer insulation layer 150. Although not shown in the figure, the first gate electrode 138 and the second gate electrode 148 are electrically connected to each other in a region that does not overlap the semiconductor layer 142. A second connecting wiring 152 is disposed on the first interlayer insulating layer 150 with the same conductive layer as the second wiring 132. The second connecting wiring 152 is connected to the first connecting wiring through a contact hole formed in the first interlayer insulating layer 150.

A second interlayer insulating layer 154 is provided so as to cover the second wiring 132 and the second connecting wiring 152. Furthermore, a planarization layer 156 is provided so as to fill the steps of the switching element 134. By providing a planarization layer 156, the patch electrode 108 can be formed without being affected by the arrangement of the switching elements 134. A passivation layer 158 is disposed over the flat surface of the planarization layer 156. The patch electrode 108 is provided on the passivation layer 158. The patch electrode 108 is connected to the second connecting wiring 152 through a contact hole formed through the passivation layer 158, the planarization layer 156, and the second interlayer insulating layer 154. The alignment film 112a is provided on the patch electrode 108.

The second substrate 106 is provided with the common electrode 110 and the alignment film 112b, as shown in FIG. 1B. The surface of the first substrate 104 on which the switching element 134 and the patch electrode 108 are provided is arranged so as to face the surface of the second substrate on which the common electrode 110 is provided, and the liquid crystal layer 114 is provided between them.

Each layer formed on the first substrate 104 is formed using the following materials. The undercoat layer 136 is formed, for example, with a silicon oxide film. The first gate insulating layer 140 and the second gate insulating layer 146 are formed, for example, with a silicon oxide film or a laminated structure of a silicon oxide film and a silicon nitride film. The semiconductor layers are formed of silicon semiconductors such as amorphous silicon and polycrystalline silicon, and oxide semiconductors including metal oxides such as indium oxide, zinc oxide, and gallium oxide. The first gate electrode 138 and the second gate electrode 148 may be configured, for example, of molybdenum (Mo), tungsten (W), or alloys thereof. The first wiring 118, the second wiring 132, the first connecting wiring 144, and the second connecting wiring 152 are formed using metal materials such as titanium (Ti), aluminum (Al), and molybdenum (Mo). For example, a titanium (Ti)/aluminum (Al)/titanium (Ti) laminate structure or a molybdenum (Mo)/aluminum (Al)/molybdenum (Mo) laminate structure may be used. The planarization layer 156 is formed of a resin material such as acrylic, polyimide, or the like. The passivation layer 158 is formed of, for example, a silicon nitride film.

As shown in FIG. 8, it is possible to select a predetermined patch electrode from the plurality of patch electrodes 108 arranged in a matrix and apply a control signal to the patch electrode, by connecting the second wiring 132 to the gate of the transistor used as the switching element 134, the first wiring 118 to one of the source and drain of the transistor, and the patch electrode 108 to the other of the source and drain. Then, it is possible to apply a control voltage to each patch electrode 108 arranged in a row along the first direction (x-axis direction) or each patch electrode 108 arranged in a row along the second direction (y-axis direction), by arranging the switching element 134 for each individual patch electrode 108 in the reflector 120, for example, when the reflector 120 is upright, the direction of reflection of the reflected wave can be controlled in the left-right and vertical directions.

As described above, the reflecting device 100 according to an embodiment of the present invention has the through hole 109 in the patch electrode 108, the transparent conductive layer 108-2 overlapping the through hole 109, the through hole 111 in the common electrode 110, and the transparent conductive layer 110-2 overlapping the through hole 111. As a result, the reflecting device 100 can achieve high reflection characteristics without spoiling the scenery. Additionally, the reflecting device 100 can control the reflection of radio waves in both the row and column directions, enabling the reflection of 5G radio waves in the desired direction.

The various configurations of the reflecting device and reflecting element illustrated as embodiments of the present invention can be combined as appropriate as long as they do not contradict each other. Based on the reflecting device and reflecting element disclosed in this specification and the drawings, any addition, deletion, or design change of configuration elements, or any addition, omission, or change of conditions of a process by a person skilled in the art as appropriate, are also included in the scope of the present invention as long as they have the gist of the invention.

It is understood that other advantageous effects different from the advantageous effects disposed by the embodiments disclosed herein, which are obvious from the description herein or which can be easily foreseen by a person skilled in the art, will naturally be disposed by the present invention.

What is claimed is:

1. An intelligent reflecting surface, comprising:
a patch electrode,
a common electrode that faces the patch electrode and is separated from the patch electrode, and
a liquid crystal layer between the patch electrode and the common electrode,
wherein the patch electrode has a first metal layer with a first through hole, and a first transparent conductive layer stacked on the first metal layer and overlapping the first through hole, and
the common electrode has a second metal layer with a second through hole overlapping the first through hole in a plan view, and a second transparent conductive layer stacked on the second metal layer and overlapping the second through hole.

2. The intelligent reflecting surface according to claim 1,
wherein the patch electrode comprises a plurality of patch electrodes arranged on a plane of incidence of radio waves, and the common electrode is arranged on a rear side of the plurality of patch electrodes.

3. The intelligent reflecting surface according to claim 1,
wherein the patch electrode comprises a plurality of patch electrodes arranged in a matrix, and the plurality of patch electrodes are connected in each row array.

4. The intelligent reflecting surface according to claim 1, further comprising,
a transistor electrically connected to the patch electrode.

5. The intelligent reflecting surface according to claim 1,
wherein the patch electrode has a quadrangle shape.
